(19) United States
(12) Patent Application Publication
(10) Pub. No.: US 2026/0117046 A1
(43) Pub. Date: Apr. 30, 2026

(54) PHOSPHORUS-CONTAINING COMPOUND, METHOD OF PREPARING THE SAME, RESIN COMPOSITION AND ARTICLE MADE THEREFROM

(71) Applicant: Elite Electronic Material (Zhongshan) Co., Ltd., Zhongshan City (CN)

(72) Inventors: Changyuan LI, Zhongshan City (CN); Zhilong HU, Zhongshan City (CN); Hezong ZHANG, Zhongshan City (CN); Hongxia PENG, Zhongshan City (CN); Jianzhao LI, Zhongshan City (CN)

(21) Appl. No.: 18/973,718

(22) Filed: Dec. 9, 2024

(30) Foreign Application Priority Data
Oct. 25, 2024 (CN) 2024115050685
Nov. 20, 2024 (CN) 2024116623218

(51) Int. Cl. C08K 5/527; C07F 9/6574

(52) U.S. Cl. CPC C08K 5/527; C07F 9/65746

(57) ABSTRACT

A phosphorus-containing compound of Formula (I), a method of preparing the same, a resin composition and an article made therefrom are provided. In Formula (I), n is 0 or 1, and Ar group represents a divalent aromatic hydrocarbon group. The phosphorus-containing compound can be used in the resin composition to improve the properties of the article, including increasing glass transition temperature, reducing ratio of thermal expansion in Z-axis, improving T288 thermal resistance, improving flame retardant migration, improving flame retardant detachment and/or improving bonding gap.

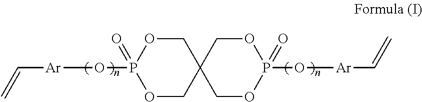

### CROSS-REFERENCE TO RELATED APPLICATION

This application claims the priority benefits of China Patent Application No. 2024115050685, filed on Oct. 25, 2024, and China Patent Application No. 2024116623218, filed on Nov. 20, 2024. The entirety of the above-mentioned patent application is hereby incorporated by reference herein and made a part of this specification.

### BACKGROUND

### 1. Field of the Disclosure

The present disclosure mainly relates to a phosphorus-containing compound, more particularly to a phosphorus-containing compound useful as a flame retardant, a method of preparing the same, a resin composition and an article made therefrom.

### 2. Description of Related Art

Halogen-containing flame retardants may possibly release toxic substances during combustion, and therefore their applications are limited due to environmental protection issues. In contrast, phosphorus-containing flame retardants draw much attention due to their low toxicity and high efficacy. However, most phosphate esters are liquid and have high volatility, so they are susceptible to migration and exudation problems. Therefore, there is an urgent need to provide a phosphate ester with high material compatibility and less exudation.

On the other hand, it is also expected that phosphorus-containing flame retardants, when used in materials such as copper-clad laminates, can achieve high flame retardancy without deteriorating various properties of copper-clad laminates, such as glass transition temperature, ratio of thermal expansion in Z-axis, T288 thermal resistance, etc. Therefore, it is a highly concerned issue in the industry to develop a phosphorus-containing flame retardant capable of not deteriorating or even improving at least one of the aforesaid properties.

### SUMMARY

To overcome the problems of prior arts, particularly one or more above-mentioned technical problems facing conventional materials, it is a primary object of the present disclosure to provide a novel phosphorus-containing compound, which improves flame retardancy and at the same time meets the property demands in at least one of glass transition temperature, ratio of thermal expansion in Z-axis, and T288 thermal resistance; meanwhile, it also avoids the problem of flame retardant migration, flame retardant detachment or bonding gap.

Another main object of the present disclosure is to provide a method of preparing the aforesaid phosphorus-containing compound.

Still another main object of the present disclosure is to provide a resin composition comprising the phosphorus-containing compound and an article made from the resin composition, the article comprising a prepreg, a resin film, a laminate, a printed circuit board or a cured insulator.

Specifically, the present disclosure provides a phosphorus-containing compound having a structure represented by Formula (I):

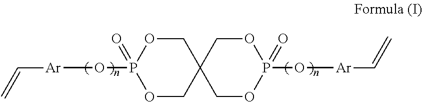

wherein n is 0 or 1, and Ar group represents a divalent aromatic hydrocarbon group.

For example, in one embodiment, the divalent aromatic hydrocarbon group comprises a phenylene group, a naphthylene group, or a biphenylene group.

For example, in one embodiment, the divalent aromatic hydrocarbon group is substituted or unsubstituted.

For example, in one embodiment, the phosphorus-containing compound has a structure represented by Formula (II):

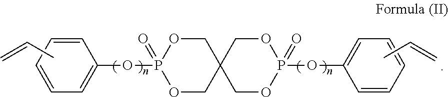

For example, in one embodiment, the phosphorus-containing compound has a structure represented by Formula (III):

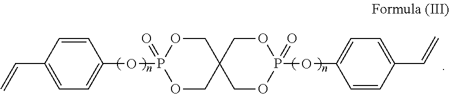

For example, in one embodiment, the phosphorus-containing compound has a phosphorus content of between 9% and 15%.

In another aspect, the present disclosure provides a method of preparing the phosphorus-containing compound having the structure represented by Formula (I), comprising: reacting a compound of Formula (A) with a compound of Formula (B) to obtain the phosphorus-containing compound having the structure represented by Formula (I):

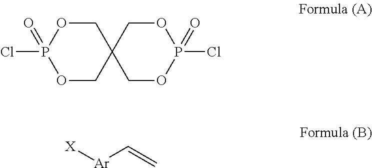

wherein X represents a hydroxyl group or a magnesium halide group, and Ar group represents a divalent aromatic hydrocarbon group.

For example, in one embodiment, the method further comprises: reacting pentaerythritol with phosphorus oxychloride to obtain the compound of Formula (A).

For example, in one embodiment, the compound of Formula (A) and the compound of Formula (B) are reacted in the presence of a deacid reagent.

For example, in one embodiment, the compound of Formula (A) and the compound of Formula (B) are reacted in the absence of a deacid reagent.

For example, in one embodiment, the compound of Formula (B) is hydroxystyrene, styryl magnesium bromide or styryl magnesium chloride.

In another aspect, the present disclosure provides a resin composition comprising 100 parts by weight of a maleimide resin and 10 parts by weight to 80 parts by weight of the phosphorus-containing compound of Formula (1).

For example, in one embodiment, the maleimide resin comprises 4,4′-diphenylmethane bismaleimide, oligomer of phenylmethane maleimide, biphenyl aralkyl bismaleimide, indane-containing bismaleimide, m-phenylene bismaleimide, bisphenol A diphenyl ether bismaleimide, 3,3′-dimethyl-5,5′-diethyl-4,4′-diphenyl methane bismaleimide, 4-methyl-1,3-phenylene bismaleimide, 1,6-bismaleimide-(2,2,4-trimethyl)hexane, N-2,3-xylylmaleimide, N-2,6-xylyl maleimide, N-phenylmaleimide, maleimide resin containing a C₅ to C₅₀ aliphatic long-chain structure, or a combination thereof.

For example, in one embodiment, the resin composition comprises 100 parts by weight of the maleimide resin and 20 parts by weight to 70 parts by weight of the phosphorus-containing compound of Formula (I).

For example, in one embodiment, the resin composition further comprises an amine curing agent, an inorganic filler, a curing accelerator, a polymerization inhibitor, a coloring agent, a solvent, a toughening agent, a silane coupling agent or a combination thereof.

In another aspect, the present disclosure provides an article made from the resin composition described above, which comprises a prepreg, a resin film, a laminate, a printed circuit board or a cured insulator.

For example, in one embodiment, articles made from the resin composition disclosed herein have one, more or all of the following properties:
a glass transition temperature as measured by using dynamic mechanical analysis by reference to IPC-TM-650 2.4.24.4 of greater than or equal to 245° C.;
a ratio of thermal expansion in Z-axis as measured by using thermal mechanical analysis by reference to IPC-TM-650 2.4.24.5 of less than or equal to 1.45%;
a time to delamination as measured by using thermal mechanical analysis by reference to IPC-TM-650 2.4.24.1 of greater than or equal to 50 minutes;
a flame retardancy of V-0 or V-1 as measured by reference to UL 94 rating;
no flame retardant migration as determined by visual inspection;
no flame retardant detachment as determined by scanning electron microscope inspection; and
no bonding gap as determined by scanning electron microscope inspection.

### BRIEF DESCRIPTION OF THE DRAWINGS

FIG. 1 illustrates the FTIR spectrum of the phosphorus-containing compound.

FIG. 2 illustrates the ¹H NMR spectrum of the phosphorus-containing compound.

FIG. 3 illustrates the LC-MS spectrum of the phosphorus-containing compound.

FIG. 4 is a picture showing a sample with flame retardant detachment.

FIG. 5 is a picture showing a sample without flame retardant detachment.

FIG. 6 and FIG. 7 are pictures showing a sample with bonding gap.

FIG. 8 is a picture showing a sample without bonding gap.

### DESCRIPTION OF THE EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

While some theories or mechanisms may be proposed herein, the present disclosure is not bound by any theories or mechanisms described regardless of whether they are right or wrong, as long as the embodiments can be implemented according to the present disclosure.

As used herein, “a,” “an” or any similar expression is employed to describe components and features of the present disclosure. This is done merely for convenience and to give a general sense of the scope of the present disclosure. Accordingly, this description should be read to include one or at least one and the singular also includes the plural unless it is obvious to mean otherwise.

As used herein, the term “comprises,” “comprising,” “includes,” “including,” “has,” “having,” “encompasses,” “encompassing,” or any other variant thereof is construed as an open-ended transitional phrase intended to cover a non-exclusive inclusion. For example, a composition or article of manufacture that comprises a list of elements is not necessarily limited to only those elements but may include other elements not expressly listed or inherent to such composition or article of manufacture. Further, unless expressly stated to the contrary, the term “or” refers to an inclusive or and not to an exclusive or. For example, a condition “P or Q” is satisfied by any one of the following: P is true (or present) and Q is false (or not present), P is false (or not present) and Q is true (or present), and both P and Q are true (or present). In addition, whenever open-ended transitional phrases are used, such as “comprises,” “comprising,” “includes,” “including,” “encompasses,” “encompassing,” “has,” “having” or any other variant thereof, it is understood that transitional phrases such as “consisting essentially of” and “consisting of” are also disclosed and included.

As used herein, the term “and” or any other variant thereof is used to connect parallel sentence components, and there is no distinction between the front and rear components. The meaning of the parallel sentence components does not change in the grammatical sense after the position is exchanged.

In this disclosure, features or conditions presented as a numerical range or a percentage range are merely for convenience and brevity. Therefore, a numerical range or a percentage range should be interpreted as encompassing and specifically disclosing all possible subranges and individual numerals or values therein, particularly all integers therein. For example, a range of “1 to 8” should be understood as explicitly disclosing all subranges such as 1 to 7, 2 to 8, 2 to 6, 3 to 6, 4 to 8, 3 to 8 and so on, particularly all subranges defined by integers, as well as disclosing all individual values such as 1, 2, 3, 4, 5, 6, 7 and 8. Similarly, a range of “between 1 and 8” should be understood as explicitly disclosing all ranges such as 1 to 8, 1 to 7, 2 to 8, 2 to 6, 3 to 6, 4 to 8, 3 to 8 and so on and encompassing the end points of the ranges. Unless otherwise defined, the aforesaid interpretation rule should be applied throughout the present disclosure regardless of broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40 should be understood as covering a range of 39.50 to 40.49, 40.0 should be understood as covering a range of 39.95 to 40.04.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X1, X2 and X3,” it is intended to disclose the situations of X is X1 and X is X1 and/or X2 and/or X3. In addition, when a Markush group or a list of items is used to describe examples or embodiments of the present disclosure, a skilled artisan will understand that any subgroup or any combination of the members or items in the Markush group or list may also be used to describe the present disclosure. Therefore, for example, when X is described as being “selected from a group consisting of X1, X2 and X3” and Y is described as being “selected from a group consisting of Y1, Y2 and Y3,” the disclosure includes any combination of X is X1 or X2 or X3 and Y is Y1 or Y2 or Y3. As used herein, “or a combination thereof” means “or any combination thereof”.

As used herein, the term “a composition comprises A, B and C, wherein A comprises a1, a2 or a3” means the same as “a composition comprises A, B and C, wherein A comprises a1, a2, a3 or a combination thereof”, that is, “a composition comprises A, B and C, wherein A comprises a1, a2, a3, a combination of a1 and a2, a combination of a1 and a3, a combination of a2 and a3, or a combination of a1, a2 and a3.”

As used herein, the term “isomer” means compounds that have the same molecular formula but differ in the bonding properties or order of their atoms or differ in the arrangement of their atoms in space.

Unless otherwise specified, the term “resin” is a widely used common name of a synthetic polymer and is construed in the present disclosure as comprising monomer and its combination, polymer and its combination or a combination of monomer and its polymer, but not limited thereto. For example, “maleimide resin” is construed to encompass a maleimide monomer (a small molecule compound of maleimide), a maleimide polymer, a combination of maleimide monomers, a combination of maleimide polymers, and a combination of maleimide monomer(s) and maleimide polymer(s).

Unless otherwise specified, according to the present disclosure, a compound refers to a chemical substance formed by two or more elements bonded with chemical bonds and may comprise a small molecule compound and a polymer compound, but not limited thereto. Any compound disclosed herein is interpreted to not only include a single chemical substance but also include a class of chemical substances having the same kind of components or having the same property. In addition, as used herein, a mixture may include two or more compounds and may include a copolymer or auxiliaries, but not limited thereto.

Unless otherwise specified, according to the present disclosure, a polymer refers to the product formed by monomer(s) via polymerization and usually comprises multiple aggregates of polymers respectively formed by multiple repeated simple structure units by covalent bonds; the monomer refers to the compound forming the polymer. A polymer may comprise a homopolymer, a copolymer, a prepolymer, etc., but not limited thereto.

A homopolymer refers to a chemical substance formed by a single compound via polymerization, addition polymerization or condensation polymerization. A copolymer refers to a chemical substance formed by two or more compounds via polymerization, addition polymerization or condensation polymerization and may comprise: random copolymers, such as a structure of -AABABBBAAABBA-; alternating copolymers, such as a structure of -ABABABAB-; graft copolymers, such as a structure shown below; and block copolymers, such as a structure of -AAAAA-BBBBBB-AAAAA-. Unless otherwise specified, according to the present disclosure, a prepolymer refers to a polymer having a lower molecular weight between the molecular weight of monomer and the molecular weight of final polymer, and a prepolymer contains a reactive functional group capable of participating further polymerization to obtain the final polymer product which has been fully crosslinked or cured.

For example, the structure of graft copolymers may be

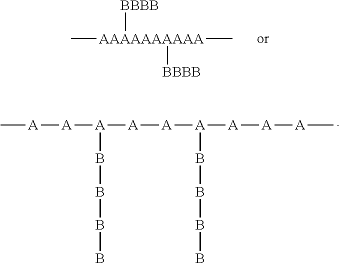

The term “polymer” includes but is not limited to an oligomer. An oligomer refers to a polymer with 2 to 20, typically 2 to 5, repeating units.

Unless otherwise specified, according to the present disclosure, a modification comprises a product derived from a resin with its reactive functional group modified, a product derived from a prepolymerization reaction of a resin and other resins, a product derived from a crosslinking reaction of a resin and other resins, a product derived from homopolymerizing a resin, a product derived from copolymerizing a resin and other resins, etc. For example, such as but not limited thereto, a modification may refer to replacing a hydroxyl group with a vinyl group via a chemical reaction, or obtaining a terminal hydroxyl group from a chemical reaction of a terminal vinyl group and p-aminophenol.

Unless otherwise specified, an alkyl group, an alkenyl group and a hydrocarbyl group described herein are construed to encompass various isomers thereof. For example, a propyl group is construed to encompass n-propyl and iso-propyl.

Unless otherwise specified, as used herein, “vinyl group-containing” refers to the presence of an ethylenic carbon-carbon double bond (C═C) or a functional group derived therefrom in a compound. Therefore, examples of “vinyl group-containing” may include, but not limited to, a structure containing a vinyl group, an allyl group, a vinylbenzyl group, a methacrylate group or the like. Unless otherwise specified, the position of the aforesaid functional group is not particularly limited and may be located at the terminal of a long-chain structure.

The unsaturated bond described herein, unless otherwise specified, refers to a reactive unsaturated bond, such as but not limited to an unsaturated double bond with the potential of being crosslinked with other functional groups, such as an unsaturated carbon-carbon double bond with the potential of being crosslinked with other functional groups, but not limited thereto.

As used herein, part(s) by weight represents weight part(s) in any weight unit, such as but not limited to kilogram, gram, pound and so on. For example, 100 parts by weight of the maleimide resin may represent 100 kilograms of the maleimide resin or 100 pounds of the maleimide resin.

The following embodiments and examples are illustrative in nature and are not intended to limit the present disclosure and its application. In addition, the present disclosure is not bound by any theory described in the background and summary above or the following embodiments or examples. Unless otherwise specified, processes, reagents and conditions described in the examples are those known in the art.

### Phosphorus-Containing Compound

As described above, the present disclosure mainly provides a phosphorus-containing compound having a structure represented by Formula (I):

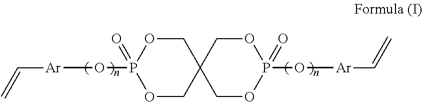

wherein n is 0 or 1, and Ar group represents a divalent aromatic hydrocarbon group.

For example, in one embodiment, the type of the divalent aromatic hydrocarbon group is not particularly limited and may be for example a phenylene group, a naphthylene group, or a biphenylene group, but not limited thereto.

For example, in one embodiment, the phenylene group may be 1,2-phenylene group, 1,3-phenylene group or 1,4-phenylene group, preferably 1,4-phenylene group, but not limited thereto. The naphthylene group may be 1,2-naphthylene group, 1,3-naphthylene group, 1,4-naphthylene group, 1,5-naphthylene group, 1,6-naphthylene group, 1,7-naphthylene group, 1,8-naphthylene group, 2,3-naphthylene group, 2,6-naphthylene group or 2,7-naphthylene group, particularly 1,5-naphthylene group or 1,6-naphthylene group, but not limited thereto. The biphenylene group may be 2,2′-biphenylene group, 2,3′-biphenylene group, 2,4′-biphenylene group, 3,3′-biphenylene group, 3,4′-biphenylene group or 4,4′-biphenylene group, particularly 4,4′-biphenylene group, but not limited thereto.

For example, in one embodiment, in the structure of Formula (I), Ar group may be an unsubstituted divalent aromatic hydrocarbon group.

For example, in another embodiment, in the structure of Formula (I), Ar group may be a substituted divalent aromatic hydrocarbon group. For example, in one embodiment, the substituent on the Ar group may be an alkyl group with 1 to 4 carbon atoms, an alkoxy group with 1 to 4 carbon atoms, an alkylamino group with 1 to 4 carbon atoms, a phenyl group or a benzyl group, but not limited thereto.

In the structure of Formula (I), n may be 0 or 1. When n is 0, each phosphorus atom (P) is directly bonded to the Ar group. When n is 1, each phosphorus atom (P) is bonded to the Ar group through an oxygen atom (O). For example, in one embodiment, when n is 0, a terminal vinyl group and a phosphorus atom in the structure of Formula (I) may be located at any two substitution positions of the divalent aromatic hydrocarbon group (i.e., Ar group). For example, in another embodiment, when n is 1, a terminal vinyl group and an oxygen atom in the structure of Formula (I) may be located at any two substitution positions of the divalent aromatic hydrocarbon group (i.e., Ar group).

For example, in one embodiment, the Ar group in the structure of Formula (I) is a phenylene group. In other words, the phosphorus-containing compound may have a structure represented by Formula (II):

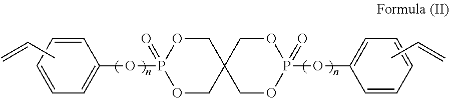

It can be observed from the structure of Formula (II) that a terminal vinyl group may be located at any substitution position on the benzene ring. For example, in one embodiment, a terminal vinyl group may be located at para position on the benzene ring, as shown in Formula (III), but not limited thereto.

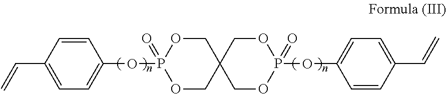

It can be observed from the structure of Formula (I), Formula (II) or Formula (III) that, in the aforementioned compounds of the present disclosure, a phosphorus-containing heterospirocyclic structure has structural symmetry and good thermal stability, and it is rich in phosphorus elements and carbon elements and has good flame retardancy. In addition, the phosphorus-containing compound of Formula (I), Formula (II) or Formula (III) has reactive double bonds at two ends, which may be crosslinked with a resin to form an interconnected network, allowing materials such as copper-clad laminates to have high glass transition temperature and lower ratio of thermal expansion. For example, in one embodiment, the phosphorus-containing compound of Formula (I), Formula (II) or Formula (III) has a phosphorus content of 9% to 15% (including 9%, 10%, 11%, 12%, 13%, 14% or 15%), such as a phosphorus content of between 13% and 15%, but not limited thereto.

On the other hand, the phosphorus-containing compound of Formula (I), Formula (II) or Formula (III) disclosed herein belongs to a reactive phosphorus-containing flame retardant. Compared to an additive phosphorus-containing flame retardant, the reactive phosphorus-containing flame retardant can participate in a crosslinking reaction, capable of effectively preventing the migration and precipitation, detachment or bonding gap of the phosphorus-containing flame retardant in materials such as copper-clad laminates.

For example, the phosphorus-containing compound of Formula (I), Formula (II) or Formula (III) contains at least two vinyl reactive functional groups that can participate in a reaction and therefore can also be used as a crosslinking agent. For example, the phosphorus-containing compound of Formula (I), Formula (II) or Formula (III) in a maleimide (BMI) resin system can achieve improvements in one, more or all properties including glass transition temperature, ratio of thermal expansion in Z-axis, T288 thermal resistance, flame retardancy, flame retardant migration, flame retardant detachment and bonding gap.

### Preparation of Phosphorus-Containing Compound

The phosphorus-containing compound of Formula (I), Formula (II) or Formula (III), or collectively referred to as the phosphorus-containing compound of the present disclosure, may be prepared by various methods.

For example, in one embodiment, the method of preparing the phosphorus-containing compound of the present disclosure comprises: reacting a compound of Formula (A) with a compound of Formula (B) to obtain the phosphorus-containing compound of the present disclosure:

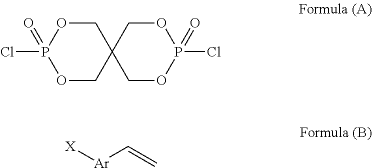

wherein X represents a hydroxyl group or a magnesium halide group (such as but not limited to a magnesium chloride group or a magnesium bromide group), and Ar group represents a divalent aromatic hydrocarbon group (such as but not limited to a phenylene group, a naphthylene group, or a biphenylene group).

The compound of Formula (A) can be synthesized by known methods or obtained commercially. For example, in one embodiment, the method further comprises: reacting pentaerythritol with phosphorus oxychloride to obtain the compound of Formula (A).

For example, in one embodiment, the method of preparing the phosphorus-containing compound of Formula (I) comprises: after reacting pentaerythritol with phosphorus oxychloride, an intermediate product pentaerythritol diphosphate diphosphoryl chloride (i.e., the compound of Formula (A)) was obtained, and then the intermediate product was reacted with hydroxystyrene (one example of the compound of Formula (B), such as but not limited to 2-hydroxystyrene, 3-hydroxystyrene or 4-hydroxystyrene) to obtain the phosphorus-containing compound having a structure represented by Formula (I), wherein n is 1.

For example, in one embodiment, pentaerythritol and phosphorus oxychloride may be reacted by heating and refluxing in a reactor. The reaction time may range from 2 hours to 10 hours, such as between 4 hours and 8 hours or between 6 hours and 7 hours, but not limited thereto.

For example, in one embodiment, the amount (molar ratio) of pentaerythritol and phosphorus oxychloride may be between 1:3 and 1:5, but not limited thereto. After the reaction was completed, excess phosphorus oxychloride may be removed to obtain an intermediate product, pentaerythritol diphosphate diphosphoryl chloride, and the yield of pentaerythritol diphosphate diphosphoryl chloride can be, for example, 60% to 70%.

For example, in one embodiment, a solvent can be added to the reaction of pentaerythritol diphosphate diphosphoryl chloride and hydroxystyrene, and the solvent may comprise but is not limited to acetonitrile, dichloromethane, dichloroethane, acetone, chloroform, benzene, toluene, tetrahydrofuran, N,N-dimethylformamide, dimethyl sulfoxide, ethyl acetate, dioxane, chlorobenzene, or a combination thereof. The amount of the solvent is not particularly limited, as long as it is sufficient to dissolve the above components and allow the reaction to proceed.

For example, in one embodiment, a deacid reagent can be added to the reaction of pentaerythritol diphosphate diphosphoryl chloride and hydroxystyrene, and the type of the deacid reagent is not particularly limited, examples including but not limited to triethylamine, diisopropylethylamine, pyridine or hexahydropyridine, such as N,N-diisopropylethylamine. The amount of the deacid reagent is not particularly limited, as long as the amount is sufficient to absorb the acid produced during the reaction so that it does not affect the reaction to proceed.

For example, in one embodiment, pentaerythritol diphosphate diphosphoryl chloride and hydroxystyrene were reacted by heating. For example, in one embodiment, the amount (molar ratio) of pentaerythritol diphosphate diphosphoryl chloride and hydroxystyrene is between 1:3 and 1:5. For example, in one embodiment, the heating temperature may be between 50° C. and 80° C., such as a heating temperature of between 60° C. and 70° C. For example, in one embodiment, the reaction time may range from 14 hours to 20 hours, such as between 14 hours and 18 hours or between 16 hours and 17 hours. For example, in one embodiment, after the aforementioned reaction was completed, the reaction solution may be subject to rotary evaporation under reduced pressure to obtain a crude product (phosphorus-containing compound of Formula (I), Formula (II) or Formula (III), wherein n is 1), which was further optionally separated and purified by column chromatography, and the yield can be, for example, 40% to 60%.

For example, in another embodiment, the method of preparing the phosphorus-containing compound of Formula (I) comprises: reacting pentaerythritol with phosphorus oxychloride to obtain an intermediate product, pentaerythritol diphosphate diphosphoryl chloride (i.e., the compound of Formula (A)), and then the intermediate product was reacted with styryl magnesium halide (one example of the compound of Formula (B), such as but not limited to 2-styryl magnesium bromide, 3-styryl magnesium bromide, 4-styryl magnesium bromide, 2-styryl magnesium chloride, 3-styryl magnesium chloride, or 4-styryl magnesium chloride) to obtain the phosphorus-containing compound having a structure represented by Formula (I), wherein n is 0.

For example, in one embodiment, pentaerythritol diphosphate diphosphoryl chloride and styryl magnesium halide were reacted in the absence of a deacid reagent.

For example, in one embodiment, a solvent can be added to the reaction of pentaerythritol diphosphate diphosphoryl chloride and styryl magnesium halide, and the solvent may comprise but is not limited to acetonitrile, dichloromethane, dichloroethane, acetone, chloroform, benzene, toluene, tetrahydrofuran, N,N-dimethylformamide, dimethyl sulfoxide, ethyl acetate, dioxane, chlorobenzene, or a combination thereof. The amount of the solvent is not particularly limited, as long as it is sufficient to dissolve the above components and allow the reaction to proceed.

For example, in one embodiment, pentaerythritol diphosphate diphosphoryl chloride and styryl magnesium halide were reacted by heating. For example, in one embodiment, the amount (molar ratio) of pentaerythritol diphosphate diphosphoryl chloride and styryl magnesium halide is between 1:3 and 1:5. For example, in one embodiment, the heating temperature may be between 50° C. and 80° C., such as a heating temperature of between 60° C. and 70° C. For example, in one embodiment, the reaction time may range from 2 hours to 18 hours, such as between 4 hours and 16 hours or between 6 hours and 14 hours. For example, in one embodiment, after the aforementioned reaction was completed, the reaction solution may be subject to rotary evaporation under reduced pressure to obtain a crude product (phosphorus-containing compound of Formula (I), Formula (II) or Formula (III), wherein n is 0), which was further optionally separated and purified by column chromatography, and the yield can be, for example, 40% to 60%.

### Synthesis and Characterization of the Phosphorus-Containing Compound

### Synthesis Example 1

In a three-necked flask inserted with a thermometer and a condensation tube, 2 moles (about 272 grams) of pentaerythritol and 6 moles (about 920 grams) of phosphorus oxychloride were added, and the resulting solution was heated to reflux for 6 hours. After the reaction was completed, excess phosphorus oxychloride was removed by rotary evaporation under reduced pressure, so as to obtain a white solid intermediate product, pentaerythritol diphosphate diphosphoryl chloride, and the yield of pentaerythritol diphosphate diphosphoryl chloride was about 68%.

In a three-neck flask inserted with a thermometer and a condensation tube, 1 mole of pentaerythritol diphosphate diphosphoryl chloride (about 296 grams) and a proper amount of chlorobenzene solvent were added, followed by adding 3 moles of 4-hydroxystyrene (about 360 grams) and a proper amount of a deacid reagent (N,N-diisopropylethylamine), heating to 60° C. and reacting for 16 hours. After the reaction was completed, excess 4-hydroxystyrene was removed by rotary evaporation, so as to obtain a white solid product, which is the phosphorus-containing compound of the present disclosure (as shown below), and the yield was about 50%. The phosphorus content of the phosphorus-containing compound was obtained by calculation (relative atomic weight of phosphorus atom*number/molecular weight of the compound*100%). For example, the phosphorus content is between 9% and 15%, preferably between 13% and 15%.

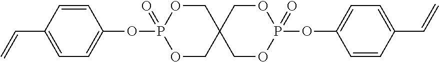 [SMILES: C=Cc1ccc(OP2(=O)OCC3(CO2)COP(=O)(Oc2ccc(C=C)cc2)OC3)cc1]

The purified phosphorus-containing compound was subjected to melting point determination, and it was found that the melting point of the phosphorus-containing compound was 198.4° C. to 200.7° C., such as between 198° C. and 201° C. or between 199° C. and 200° C. On the other hand, the purified phosphorus-containing compound was also subjected to thermogravimetric analysis. From the thermogravimetric analysis results of the phosphorus-containing compound, it can be confirmed that when the phosphorus-containing compound decomposes 1%, its thermal decomposition temperature 1 is 384.03° C.; when the phosphorus-containing compound decomposes 2%, its thermal decomposition temperature 2 is 398.61° C.; and when the phosphorus-containing compound decomposes 5%, its thermal decomposition temperature 3 is 403.61° C.

The melting point determination method was performed by reference to the first method B in determination of melting point, ChP2020 Vol IV General Chapter 0612. The specific steps include: after the sample was dried, a proper amount was placed in a capillary tube for melting point determination. The heating block of the automatic melting point apparatus was heated to 190° C. and inserted by the capillary tube containing the sample, followed by heating at a set heating rate of 1.0° C./minute to 215° C. The measurement was repeated for 5 times, and the average was taken to obtain the melting point.

The aforementioned thermogravimetric analysis was performed by reference to the method recorded in IPC-TM-650 2.4.24.6. The specific steps include: the copper-free laminate 1 (preparation method as described below) was baked at 120° C. for 2 hours and put in a dryer box to cool for 30 minutes. Next, 25±5 mg of the sample was taken from the copper-free laminate 1 and placed into a thermogravimetric analyzer, which was heated to 550° C. in nitrogen atmosphere at a heating rate of 10° C./minute. The temperatures corresponding to 1%, 2% and 5% weight loss were recorded respectively.

In addition, the phosphorus-containing compound prepared in Synthesis Example 1 was purified and then subjected to Fourier-transform infrared spectroscopy (FTIR), nuclear magnetic resonance spectroscopy (¹H NMR and ³¹P NMR) and liquid chromatography-mass spectrometry (LC-MS) analysis. The results are as follows.

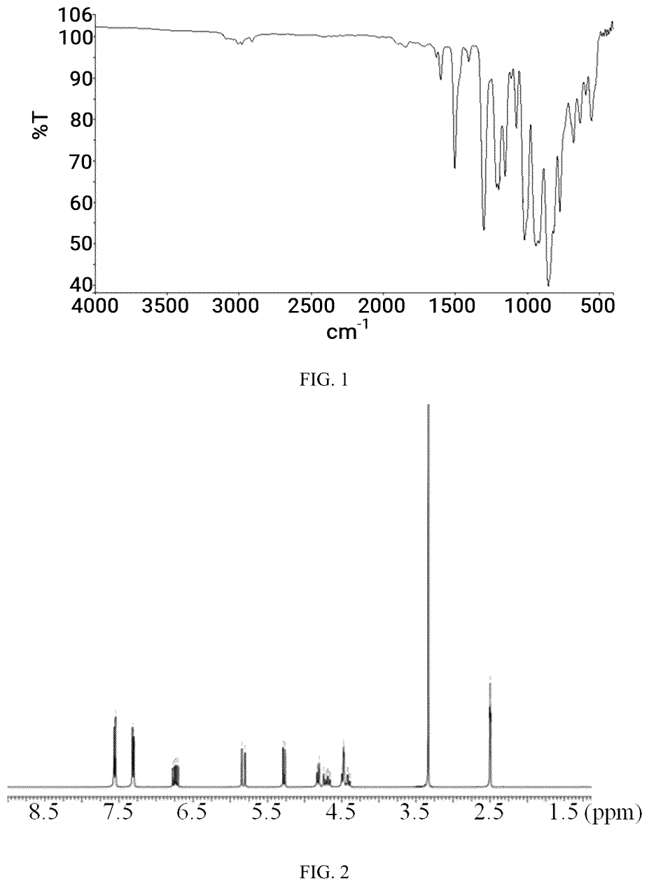

FIG. 1 illustrates the FTIR spectrum of the phosphorus-containing compound prepared in Synthesis Example 1. It can be observed from the spectrum that the absorption peaks at 1600 cm⁻¹ and 1502 cm⁻¹ indicate the presence of a benzene ring skeleton in the phosphorus-containing compound; the absorption peaks at 3078 cm⁻¹ and 1630 cm⁻¹ correspond to C═C—H bond, the absorption peak at 1300 cm⁻¹ corresponds to P═O bond; the absorption peaks at 1152 cm⁻¹ and 1017 cm⁻¹ correspond to P—O—C bond; and the absorption peaks at 852 cm⁻¹ and 771 cm⁻¹ are attributed to vibrations of the pentaerythritol spirocarbon skeleton, which are consistent with the expected structure of Synthesis Example 1, preliminarily confirming that the phosphorus-containing compound of Formula (I) has been synthesized.

FIG. 2 illustrates the ¹H NMR spectrum of the phosphorus-containing compound prepared in Synthesis Example 1. It can be observed from the spectrum that this phosphorus-containing compound has six different chemical environments for hydrogen atoms, each corresponding to the chemical shifts of hydrogen atoms at six different positions in the ¹H NMR spectrum, wherein the chemical shift (δ) at 4.2 to 5.0 ppm corresponds to hydrogen atoms in the —CH₂— groups in pentaerythritol; the chemical shift at 5.2 to 6.0 ppm corresponds to hydrogen atoms in the terminal vinyl —CH₂ groups; the chemical shift at 6.5 to 7.0 ppm corresponds to hydrogen atoms in the terminal vinyl —CH— groups; and the chemical shift at 7.3 to 7.6 ppm corresponds to hydrogen atoms in two types of —CH— group in the benzene ring (adjacent to the C on the benzene ring near the —C—O— bond in vinylphenoxy group and adjacent to the C on the benzene ring near the —C—C— bond in vinylphenoxy group, respectively), which are sufficient to confirm that the phosphorus-containing compound of Formula (I) has been synthesized.

In addition, from the above structure, it can be confirmed that the phosphorus-containing compound prepared in Synthesis Example 1 has two phosphorus atoms in the same chemical environment. Correspondingly, from the results of the ³¹P NMR spectrum of the phosphorus-containing compound prepared in Synthesis Example 1, it can be observed that only one peak at a chemical shift of −13.666 ppm, indicating that there is only one chemical environment for the phosphorus atoms in this compound, which also indicates that the phosphorus-containing compound has a symmetrical structure, consistent with the expected structure of Synthesis Example 1.

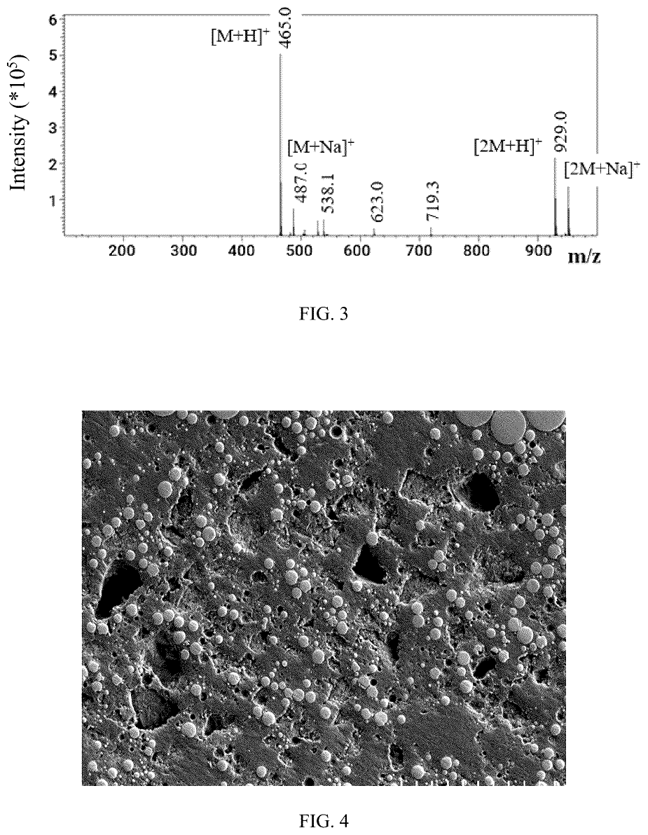

FIG. 3 illustrates the LC-MS spectrum of the phosphorus-containing compound prepared in Synthesis Example 1. The molecular weight of the tested compound is calculated to be 464.35. Compared to the theoretical molecular weight calculated from the molecular structure of the phosphorus-containing compound, it can be seen that the measured molecular weight matches the theoretical molecular weight, indicating that the phosphorus-containing compound has been synthesized.

### Synthesis Example 2

The pentaerythritol diphosphate diphosphoryl chloride was obtained by reference to the method of Synthesis Example 1. In the absence of a deacid reagent, 3 moles of 4-styryl magnesium chloride (about 495 grams, available from Suzhou Siso New Material Co., Ltd.) and 1 mole of pentaerythritol diphosphate diphosphoryl chloride (about 296 grams) were heated to 60° C. in a three-neck flask and reacted for 8 hours. After the reaction was completed, excess 4-styryl magnesium chloride was removed by rotary evaporation under reduced pressure, so as to obtain a white solid product, which is the phosphorus-containing compound of Formula (I) (as shown below), and the yield was about 45%.

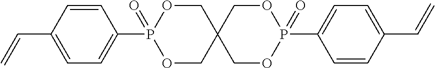 [SMILES: C=Cc1ccc(P2(=O)OCC3(CO2)COP(=O)(c2ccc(C=C)cc2)OC3)cc1]

In Synthesis Example 2, 4-styryl magnesium chloride can also be replaced by other organic magnesium halides, such as but not limited to 4-styryl magnesium bromide. The structures of 4-styryl magnesium chloride and 4-styryl magnesium bromide are shown as follows.

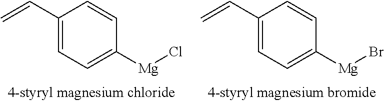

### Resin Composition

As described above, another main object of the present disclosure is to provide a resin composition comprising 100 parts by weight of a maleimide resin and 10 parts by weight to 80 parts by weight of the phosphorus-containing compound of Formula (1).

For example, in one embodiment, the maleimide resin may be a multi-functional maleimide resin. In one embodiment, the maleimide resin may comprise 4,4′-diphenylmethane bismaleimide, oligomer of phenylmethane maleimide, biphenyl aralkyl bismaleimide, indane-containing bismaleimide, m-phenylene bismaleimide, bisphenol A diphenyl ether bismaleimide, 3,3′-dimethyl-5,5′-diethyl-4,4′-diphenyl methane bismaleimide, 4-methyl-1,3-phenylene bismaleimide, 1,6-bismaleimide-(2,2,4-trimethyl)hexane, N-2,3-xylylmaleimide, N-2,6-xylylmaleimide, N-phenylmaleimide, maleimide resin containing a C₅ to C₅₀ aliphatic long-chain structure, or a combination thereof, but not limited thereto.

For example, the maleimide resin may include products such as BMI-1000, BMI-1000H, BMI-1100, BMI-1100H, BMI-2000, BMI-2300, BMI-3000, BMI-3000H, BMI-4000H, BMI-5000, BMI-5100, BMI-7000 and BMI-7000H available from Daiwakasei Industry Co., Ltd., products such as BMI-70 and BMI-80 available from K.I Chemical Industry Co., Ltd., products such as MIR-3000 and MIR-5000 available from Nippon Kayaku, or products such as X9-470, NE-X-9470S and NE-X-9480 available from D.I.C. Corporation.

For example, the maleimide resin containing a C₅ to C₅₀ aliphatic long-chain structure may include products such as BMI-689, BMI-1400, BMI-1500, BMI-1700, BMI-2500, BMI-3000, BMI-5000 and BMI-6000 available from Designer Molecules Inc. For example, the maleimide resin containing a C₅ to C₅₀ aliphatic long-chain structure may have at least one maleimide group bonded with a substituted or unsubstituted C₅ to C₅₀ long-chain aliphatic group. The carbon number of the C₅ to C₅₀ aliphatic long-chain structure may be C₁₀ to C₅₀, C₂₀ to C₅₀, C₃₀ to C₅₀, C₂₀ to C₄₀ or C₃₀ to C₄₀, but not limited thereto. Examples of commercial maleimide resins containing aliphatic long-chain structure include:

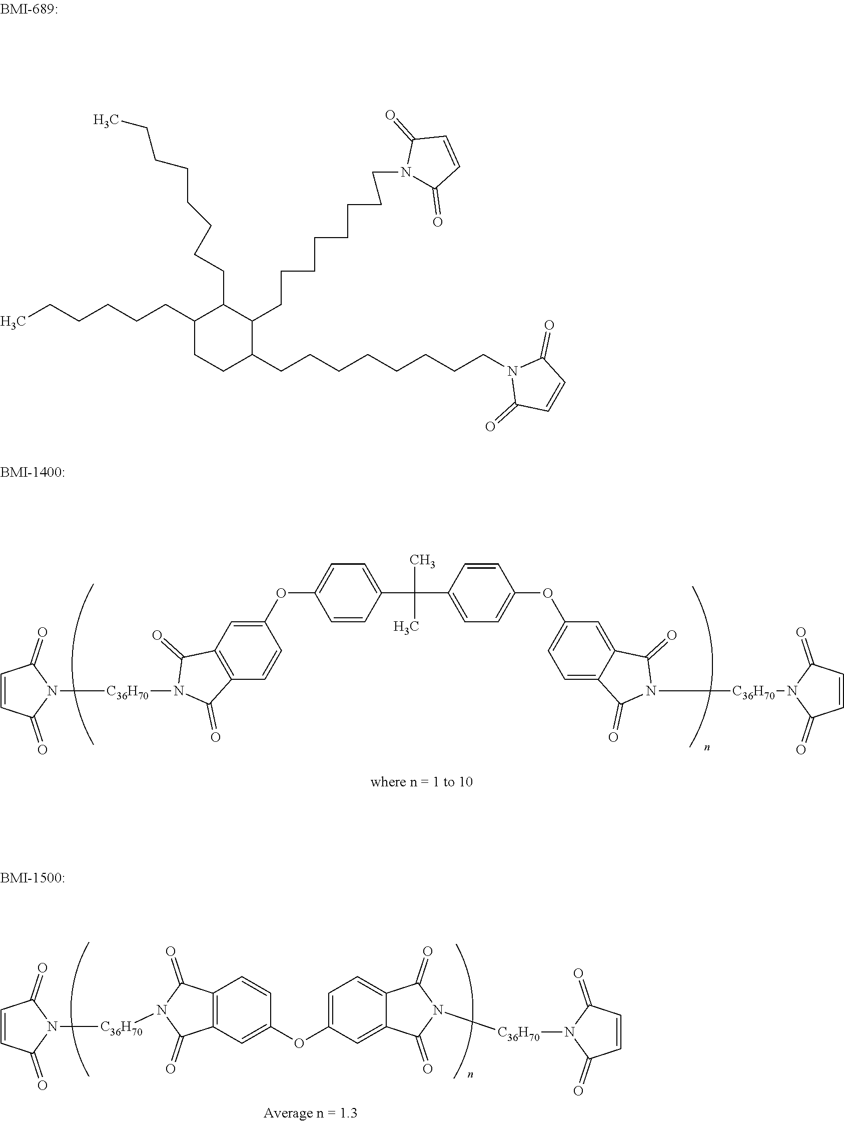

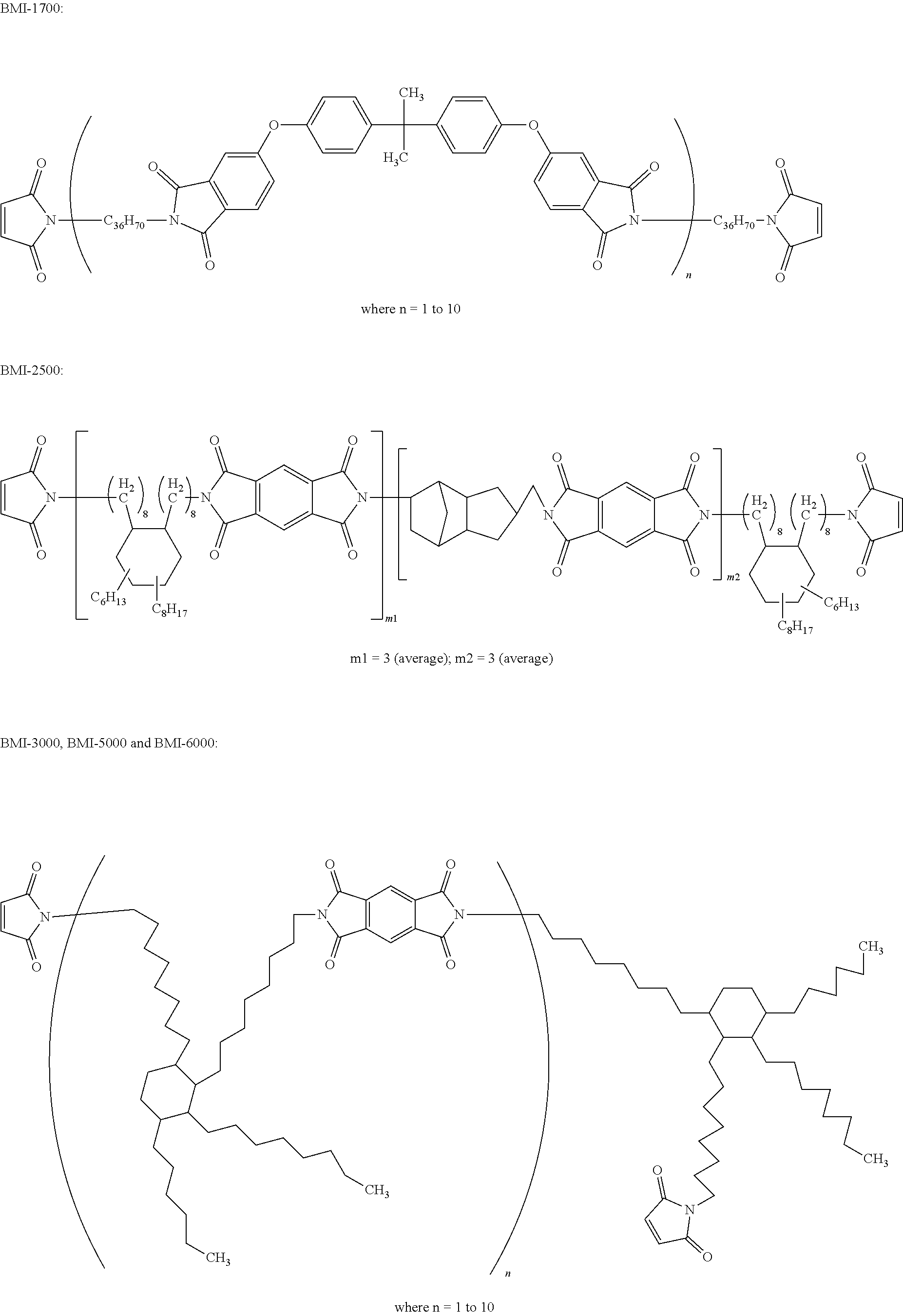

For example, in one embodiment, the resin composition comprises 100 parts by weight of the maleimide resin and 20 parts by weight to 70 parts by weight of the phosphorus-containing compound of Formula (I).

For example, in one embodiment, the resin composition may further comprise an amine curing agent, an inorganic filler, a curing accelerator, a polymerization inhibitor, a coloring agent, a solvent, a toughening agent, a silane coupling agent or a combination thereof.

According to the present disclosure, for example, the amine curing agent may be any amine curing agents known in the field to which this disclosure pertains. Examples include but are not limited to any one or a combination of diaminodiphenyl sulfone, diaminodiphenyl methane, diaminodiphenyl ether, diaminodiphenyl sulfide and dicyandiamide. Unless otherwise specified, in the resin composition of the present disclosure, relative to a total of 100 parts by weight of the maleimide resin, the amount of the amine curing agent is not particularly limited, such as may be 1 part by weight to 15 parts by weight, such as but not limited to 1 part by weight, 4 parts by weight, 7.5 parts by weight, 12 parts by weight or 15 parts by weight.

In one embodiment, the resin composition comprises an inorganic filler. The inorganic filler may be any one or more fillers useful for making a resin film, a prepreg, a laminate, a printed circuit board or a cured insulator. The inorganic filler may be silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, zinc oxide, zirconium oxide, mica, boehmite (AlOOH), calcined talc, talc, silicon nitride, calcined kaolin, or a combination thereof, but not limited thereto. The inorganic filler may be spherical, fibrous, plate-like, particulate, flake-like or whisker-like. The inorganic filler may be pre-treated by a silane coupling agent (particularly amino group-containing silane coupling agent). The inorganic filler may be spherical silica pre-treated by an amino group-containing silane coupling agent. The amount of the inorganic filler is not particularly limited. In one embodiment, relative to 100 parts by weight of all the resins in the resin composition (excluding silane coupling agents, curing accelerators, solvents and inorganic fillers), the resin composition may comprise 20 parts by weight to 300 parts by weight of an inorganic filler, preferably 50 parts by weight to 250 parts by weight, but not limited thereto.

In one embodiment, the resin composition comprises a curing accelerator. The curing accelerator may comprise a catalyst, such as a Lewis base or a Lewis acid. The Lewis base may comprise imidazole, boron trifluoride-amine complex, ethyltriphenyl phosphonium chloride, 2-methylimidazole (2MI), 2-phenyl-1H-imidazole (2PZ), 2-ethyl-4-methylimidazole (2E4MI), triphenylphosphine (TPP), 4-dimethylaminopyridine (DMAP), or a combination thereof, but not limited thereto. The Lewis acid may comprise metal salt compounds, such as those of manganese, iron, cobalt, nickel, copper and zinc, particularly metal catalysts such as zinc octanoate and cobalt octanoate, but not limited thereto. The curing accelerator may comprise a curing initiator (i.e., initiator). The curing initiator may comprise peroxide capable of producing free radicals. The curing initiator comprises 2,3-dimethyl-2,3-diphenylbutane, dicumyl peroxide, t-butyl peroxybenzoate, tert-butyl peroxyisopropyl carbonate, dibenzoyl peroxide (BPO), 2,5-dimethyl-2,5-di(t-butylperoxy)-3-hexyne (25B), bis(t-butylperoxy isopropyl)benzene, azobisisobutyronitrile, or a combination thereof, but not limited thereto. For example, in one embodiment, relative to 100 parts by weight of the maleimide resin, the resin composition may further comprise 0.01 part by weight to 2.0 parts by weight of a curing accelerator, preferably 0.3 part by weight to 1.5 parts by weight of a curing accelerator, but not limited thereto.

In one embodiment, for example, the polymerization inhibitor used herein is not particularly limited and may be any polymerization inhibitor known in the field to which this disclosure pertains, including but not limited to various commercially available polymerization inhibitor products. For example, the polymerization inhibitor may comprise, but not limited to, 1,1-diphenyl-2-picrylhydrazyl radical, methyl acrylonitrile, dithioester, nitroxide-mediated radical, triphenylmethyl radical, metal ion radical, sulfur radical, hydroquinone, 4-methoxyphenol, p-benzoquinone, phenothiazine, β-phenylnaphthylamine, 4-t-butylcatechol, methylene blue, 4,4′-butylidenebis(6-t-butyl-3-methylphenol), 2,2′-methylenebis(4-ethyl-6-t-butylphenol) or a combination thereof. For example, the nitroxide-mediated radical may comprise, but not limited to, nitroxide radicals derived from cyclic hydroxylamines, such as 2,2,6,6-substituted piperidine 1-oxyl free radical, 2,2,5,5-substituted pyrrolidine 1-oxyl free radical or the like. Preferred substitutes include alkyl groups with 4 or fewer carbon atoms, such as methyl group or ethyl group. Examples of the compound containing a nitroxide radical include such as 2,2,6,6-tetramethylpiperidine 1-oxyl free radical, 2,2,6,6-tetraethylpiperidine 1-oxyl free radical, 2,2,6,6-tetramethyl-4-oxo-piperidine 1-oxyl free radical, 2,2,5,5-tetramethylpyrrolidine 1-oxyl free radical, 1,1,3,3-tetramethyl-2-isoindoline oxygen radical, N,N-di-tert-butylamine oxygen free radical and so on. Nitroxide radicals may also be replaced by using stable radicals such as galvinoxyl radicals. The polymerization inhibitor suitable for the resin composition of the present disclosure may include products derived from the polymerization inhibitor with its hydrogen atom or group substituted by other atom or group. Examples include products derived from a polymerization inhibitor with its hydrogen atom substituted by an amino group, a hydroxyl group, a carbonyl group or the like. For example, in one embodiment, relative to a total of 100 parts by weight of the maleimide resin, the resin composition of the present disclosure may further comprise 0.001 part by weight to 2 parts by weight of a polymerization inhibitor.

According to the present disclosure, for example, the coloring agent may comprise but is not limited to dye or pigment.

According to the present disclosure, for example, the solvent may be any solvents suitable for dissolving the resin composition of the present disclosure, including but not limited to: methanol, ethanol, ethylene glycol monomethyl ether, acetone, butanone (methyl ethyl ketone), methyl isobutyl ketone, cyclohexanone, N-methyl-pyrrolidone, toluene, xylene, methoxyethyl acetate, ethoxyethyl acetate, propoxyethyl acetate, ethyl acetate, dimethylformamide, dimethylacetamide, propylene glycol monomethyl ether acetate, or a mixture thereof. The amount of solvent is determined in view of the purpose of completely dissolving the resin and adjusting to a certain total solid content of the resin composition. For example, in one embodiment, the amount of solvent is added to adjust the total solid content of the resin composition to 50% to 85% by weight, but not limited thereto. The solvent added to the resin composition can be evaporated and removed during the processing of the resin composition into an article such as a prepreg or a resin film, so that the insulation layer of the article such as a prepreg or resin film does not contain solvent or only contains trace amount of solvent of less than or equal to 3 wt % (i.e., 3% by weight). Therefore, the presence or absence of the solvent in the resin composition does not affect the properties of the article.

According to the present disclosure, the main purpose of adding a toughening agent is to improve the toughness of the resin composition. For example, the toughening agent suitable for the present disclosure may comprise, but not limited to, carboxyl-terminated butadiene acrylonitrile rubber (CTBN rubber), core-shell rubber, ethylene propylene rubber or a combination thereof.

According to the present disclosure, for example, the silane coupling agent may comprise silane (such as but not limited to siloxane), which may be further categorized according to the functional groups into amino silane, epoxide silane, vinyl silane, hydroxyl silane, isocyanate silane, methacryloxy silane and acryloxy silane. For example, in one embodiment, relative to a total of 100 parts by weight of the maleimide resin, the resin composition of the present disclosure may further comprise 0.001 part by weight to 10 parts by weight of a silane coupling agent, preferably 0.01 part by weight to 5 parts by weight of a silane coupling agent, but not limited thereto.

Article Made from the Resin Composition

In addition to the aforesaid resin composition, the present disclosure further provides an article made from the aforesaid resin composition, such as an article suitable for use as components in electronic products, including but not limited to: a prepreg, a resin film, a laminate, a printed circuit board or a cured insulator. The article may comprise the resin composition at a semi-cured state (B-stage) or cured state (C-stage). The article may comprise a resin layer, wherein the resin layer is the resin composition at a semi-cured state or cured state. The article may comprise an insulation layer, wherein the insulation layer is the resin composition at a cured state.

For example, the resin composition of the present disclosure can be used to make a prepreg, which comprises a reinforcement material and a layered structure disposed thereon. The layered structure is formed by heating the resin composition at a high temperature to the semi-cured state (B-stage). Suitable baking temperature for making a prepreg may be for example 100° C. to 200° C., preferably 120° C. to 160° C. For example, the reinforcement material may be any one of a fiber material, woven fabric, and non-woven fabric, and the woven fabric preferably comprises fiberglass fabrics. The type of the fiberglass fabric is not particularly limited and may be any fiberglass fabrics used for a printed circuit board, such as E-glass fabric, D-glass fabric, S-glass fabric, T-glass fabric, L-glass fabric, Q-glass fabric or QL-glass fabric (glass fabric with hybrid structure made of Q-glass and L-glass). The fiber may comprise yarns and rovings, in spread form or standard form, and the shape of terminal face may be round or flat. Non-woven fabric preferably comprises liquid crystal polymer non-woven fabric, such as polyester non-woven fabric, polyurethane non-woven fabric and so on, but not limited thereto. Woven fabric may also comprise liquid crystal polymer woven fabric, such as polyester woven fabric, polyurethane woven fabric and so on, but not limited thereto. The reinforcement material may increase the mechanical strength of the prepreg. In one preferred embodiment, the reinforcement material can also be optionally pre-treated by a silane coupling agent. The prepreg may be further heated and cured to the cured state (C-stage) to form an insulation layer.

For example, the resin composition of the disclosure can be used to make a resin film, which is prepared by heating and baking to semi-cure the resin composition. The resin composition may be selectively coated on a supporting material, which includes but is not limited to a liquid crystal polymer film, a polytetrafluoroethylene film, a polyethylene terephthalate film (PET film), a polyimide film (PI film), a copper foil or a resin-coated copper (RCC), followed by heating and baking to semi-cure the resin composition to form the resin film.

For example, the resin composition of the present disclosure may be made into a laminate, which comprises at least two metal foils and at least one insulation layer disposed between the metal foils, wherein the insulation layer is made by curing the resin composition at high temperature and high pressure to the C-stage, a suitable curing temperature being for example between 180° C. and 250° C. and preferably between 210° C. and 240° C. and a suitable curing time being 80 to 180 minutes and preferably 100 to 150 minutes. The insulation layer may be obtained by curing the aforesaid prepreg or resin film. The metal foil may contain copper, aluminum, nickel, platinum, silver, gold or alloy thereof, such as a copper foil. In a preferred embodiment, the laminate is a copper-clad laminate.

In one embodiment, the laminate may be further processed by trace formation processes to obtain a printed circuit board.

For example, in one embodiment, the resin composition of the present disclosure may be further made into a cured insulator, which is obtained by curing the aforementioned resin composition through a single curing process or through multiple curing processes, wherein multiple curing processes refer to curing of greater than or equal to two times. For example, the resin composition may be semi-cured (B-stage) and then further cured to the C-stage to obtain a cured insulator. The cured insulator may include the resin composition in a cured state, the resin composition in a cured state containing reinforcement materials or a combination thereof. The preferred method of semi-curing or curing is heating, such as baking heating. In one embodiment, a suitable semi-curing temperature may be for example between 100° C. and 200° C., preferably between 120° C. and 160° C. A suitable curing temperature may be for example between 180° C. and 250° C., preferably between 210° C. and 240° C. A suitable curing time may be for example 80 to 180 minutes, preferably 100 to 150 minutes. The curing (C-stage) method may be further performed under pressure.

The cured insulator may include the resin composition in a cured state. In one embodiment, the present disclosure provides a preparation method for a cured insulator, including: curing the resin film. The preparation method of the cured insulator may include: coating the resin composition on a substrate (such as a polyethylene terephthalate film (PET film), a polyimide film (PI film), a copper foil or a resin-coated copper); semi-curing the resin composition to form a resin film; and curing the resin film. The preferred method of semi-curing or curing is heating, such as baking heating.

The cured insulator may include the resin composition in a cured state containing reinforcement materials. In some embodiments, the present disclosure provides a preparation method for a cured insulator, including: curing the prepreg. The preparation method of the cured insulator may include: disposing the resin composition on the reinforcement material; semi-curing the resin composition to form a prepreg containing reinforcement materials and a semi-cured layer; and curing the prepreg. The preferred method of semi-curing or curing is heating, such as baking heating.

The preparation method of the cured insulator may include molding. For example, the resin composition or the semi-cured resin composition can be placed into a mold, and the resin composition or the semi-cured resin composition can be formed and cured in the mold under a curing temperature and a certain pressure, thereby obtaining a cured insulator with a specific shape.

The cured insulator may be an insulation layer without metal on the surface obtained by removing the metal foil on the surface of the laminate or the printed circuit board.

Preferably, the resin composition containing the phosphorus-containing compound of Formula (I) disclosed herein or an article made therefrom may achieve improvements in one or more properties including glass transition temperature, ratio of thermal expansion in Z-axis, T288 thermal resistance, flame retardancy, flame retardant migration, flame retardant detachment and bonding gap.

For example, in one embodiment, the resin composition of the present disclosure and various articles made therefrom may preferably have any one, more or all of the following properties:
a glass transition temperature as measured by using dynamic mechanical analysis by reference to IPC-TM-650 2.4.24.4 of greater than or equal to 245° C., such as between 245° C. and 269° C. or between 258° C. and 269° C.;
a ratio of thermal expansion in Z-axis as measured by using thermal mechanical analysis by reference to IPC-TM-650 2.4.24.5 of less than or equal to 1.45%, such as between 0.95% and 1.45% or between 0.95% and 1.21%;
a time to delamination as measured by using thermal mechanical analysis by reference to IPC-TM-650 2.4.24.1 of greater than or equal to 50 minutes, such as a time to delamination of greater than or equal to 60 minutes;
a flame retardancy of V-0 or V-1 as measured by reference to UL 94 rating, such as a flame retardancy of V-0;
no flame retardant migration in the article (such as a flame retardant migration test sample) as determined by visual inspection;
no flame retardant detachment in the article (such as a flame retardant detachment test sample) as determined by SEM inspection; and
no bonding gap in the article (such as a bonding gap test sample) as determined by SEM inspection.

Raw materials below are used to prepare the resin compositions of various Examples and Comparative Examples of the present disclosure according to the amount listed in Table 1 to Table 3 and further fabricated to prepare test samples or articles. Compositions and test results of resin compositions of various Examples and Comparative Examples of the present disclosure used herein are listed below in Table 1 to Table 3 (in part by weight).
X9-470: indane-containing bismaleimide, available from DIC Corporation.
MIR-5000: as shown below, available from Nippon Kayaku, wherein 1≤n≤5.

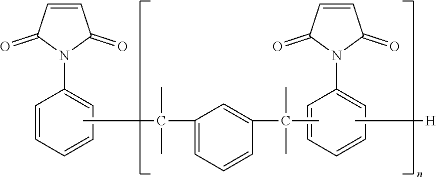

Phosphorus-containing compound 1: prepared by Synthesis Example 1.
Phosphorus-containing compound 2: prepared by Synthesis Example 2.
FCX-210: as shown below, available from Teijin Limited.

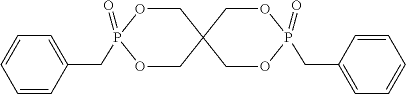 [SMILES: O=P1(Cc2ccccc2)OCC2(CO1)COP(=O)(Cc1ccccc1)OC2]

PX-200: resorcinol bis-(dixylenyl phosphate) (condensation polymer), also known as 1,3-phenylene tetrakis(2,6-dimethylphenyl) diphosphate (condensation polymer), available from Daihachi Chemical Industry Co., Ltd.
Comparative compound 1: prepared according to the following method.

1 mole of pentaerythritol diphosphate diphosphoryl chloride (about 296 grams), a proper amount of chlorobenzene solvent and 3 moles of vinyl magnesium chloride (about 260 grams) were added to a three-neck flask and heated to 60° C. to react for 8 hours. After the reaction was completed, excess vinyl magnesium chloride was removed by rotary evaporation under reduced pressure, so as to obtain a white solid product, which is the comparative compound 1, having the structure below.

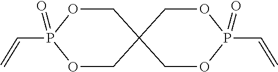 [SMILES: C=CP1(=O)OCC2(CO1)COP(=O)(C=C)OC2]

Comparative compound 2: prepared according to the following method.

1 mole of pentaerythritol diphosphate diphosphoryl chloride (about 296 grams), a proper amount of chlorobenzene solvent, a proper amount of a deacid reagent N,N-diisopropylethylamine and 3 moles of 4-hydroxybenzene (about 282 grams) were added to a three-neck flask and heated to 60° C. to react for 16 hours. After the reaction was completed, excess 4-hydroxybenzene was removed by rotary evaporation under reduced pressure, so as to obtain a white solid product, which is the comparative compound 2, having the structure below.

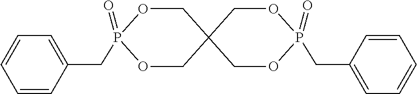 [SMILES: O=P1(Cc2ccccc2)OCC2(CO1)COP(=O)(Cc1ccccc1)OC2]

Distyryl pentaerythritol diphosphite: available from Zhejiang Wansheng Co., Ltd.
Allyl phosphate: as shown below, prepared according to the method described in the patent specification of CN110938234A.

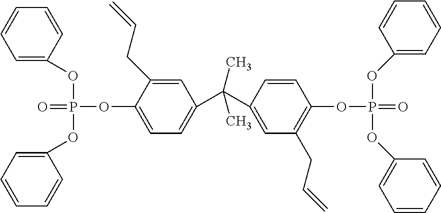 [SMILES: C=CCc1cc(C(C)(C)c2ccc(OP(=O)(Oc3ccccc3)Oc3ccccc3)c(CC=C)c2)ccc1OP(=O)(Oc1ccccc1)Oc1ccccc1]

25B: 2,5-dimethyl-2,5-di(t-butylperoxy)-3-hexyne, available from NOF Corporation.
SC-2500 SMJ: spherical silica pre-treated by acrylate silane coupling agent, available from Admatechs.
Toluene: available from Chambeco Group.
Methyl ethyl ketone: commercially available, source not limited.

In the Tables, “Z” represents the total amount of components excluding (i.e., not containing) curing accelerator, inorganic filler and solvent in the resin composition of each Example or each Comparative Example. For example, “Z*1.0” represents that the amount of inorganic filler is 1.0 time of “Z”. For example, in Example E1, “Z*1.0” represents that the amount of inorganic filler is 120 parts by weight (120 parts by weight multiplied by 1.0).

The amount of solvent is shown as “PA” in the Tables to indicate a “proper amount” to represent an amount of solvents used to achieve a desirable solid content of the whole resin composition. For a resin composition comprising methyl ethyl ketone and toluene as solvents, “PA” represents the total amount of the two solvents used to achieve a desirable solid content of the whole resin composition, such as but not limited to a solid content of 70 wt %.

Compositions and test results of resin compositions of Examples and Comparative Examples used herein are listed below in Table 1 to Table 3 (in part by weight):

TABLE 1
Resin compositions of Examples (in part by weight) and test results

| Component | | E1 | E2 | E3 | E4 | E5 |
|---|---|---|---|---|---|---|
| maleimide resin | X9-470 | 100 | 100 | 100 | | 100 |
| | MIR-5000 | | | | 100 | |
| flame retardant | phosphorus-containing | 20 | 50 | 70 | 50 | |
| | compound 1 | | | | | |
| | phosphorus-containing | | | | | 50 |
| | compound 2 | | | | | |
| | FCX-210 | | | | | |
| | PX-200 | | | | | |
| | comparative compound 1 | | | | | |
| | comparative compound 2 | | | | | |
| | distyryl pentaerythritol | | | | | |
| | diphosphite | | | | | |
| | allyl phosphate | | | | | |
| curing accelerator | 25B | 0.5 | 0.5 | 0.5 | 0.5 | 0.5 |
| inorganic filler | SC-2500 SMJ | Z*1.0 | Z*1.0 | Z*1.0 | Z*1.0 | Z*1.0 |
| solvent | toluene | PA | PA | PA | PA | PA |
| | MEK | PA | PA | PA | PA | PA |

| Property test | Unit | E1 | E2 | E3 | E4 | E5 |
|---|---|---|---|---|---|---|
| DMA-Tg | ° C. | 265 | 261 | 258 | 259 | 260 |
| Z-PTE | % | 1.05 | 1.10 | 1.21 | 1.15 | 1.05 |
| T288 | minute | >60 | >60 | >60 | >60 | >60 |
| flame retardancy | none | V-0 | V-0 | V-0 | V-0 | V-0 |
| flame retardant | none | no | no | no | no | no |
| migration | | | | | | |
| flame retardant | none | N | N | N | N | N |
| detachment | | | | | | |
| bonding gap | none | none | none | none | none | none |

TABLE 2
Resin compositions of Examples (in part by weight) and test results

| Component | | E6 | E7 | E8 | E9 | E10 |
|---|---|---|---|---|---|---|
| maleimide resin | X9-470 | 100 | 100 | 70 | 100 | 100 |
| | MIR-5000 | | | 30 | | |
| flame retardant | phosphorus-containing | 50 | 50 | 25 | 10 | 80 |
| | compound 1 | | | | | |
| | phosphorus-containing | | | 25 | | |
| | compound 2 | | | | | |
| | FCX-210 | | | | | |
| | PX-200 | | | | | |
| | comparative compound 1 | | | | | |
| | comparative compound 2 | | | | | |
| | distyryl pentaerythritol | | | | | |
| | diphosphite | | | | | |
| | allyl phosphate | | | | | |
| curing accelerator | 25B | 0.3 | 1.5 | 0.5 | 0.5 | 0.5 |
| inorganic filler | SC-2500 SMJ | Z*0.5 | Z*2.5 | Z*1.0 | Z*1.0 | Z*1.0 |
| solvent | toluene | PA | PA | PA | PA | PA |
| | MEK | PA | PA | PA | PA | PA |

| Property test | Unit | E6 | E7 | E8 | E9 | E10 |
|---|---|---|---|---|---|---|
| DMA-Tg | ° C. | 259 | 269 | 258 | 268 | 245 |
| Z-PTE | % | 1.20 | 0.95 | 1.15 | 1.00 | 1.45 |
| T288 | minute | >60 | >60 | >60 | >60 | 50 |
| flame retardancy | none | V-0 | V-0 | V-0 | V-1 | V-0 |
| flame retardant | none | no | no | no | no | no |
| migration | | | | | | |
| flame retardant | none | N | N | N | N | N |
| detachment | | | | | | |
| bonding gap | none | none | none | none | none | none |

TABLE 3
Resin compositions of Comparative Examples (in part by weight) and test results

| Component | | C1 | C2 | C3 | C4 | C5 | C6 |
|---|---|---|---|---|---|---|---|
| maleimide resin | X9-470 | 100 | 100 | 100 | 100 | 100 | 100 |
| | MIR-5000 | | | | | | |
| flame retardant | phosphorus-containing | | | | | | |
| | compound 1 | | | | | | |
| | phosphorus-containing | | | | | | |
| | compound 2 | | | | | | |
| | FCX-210 | 50 | | | | | |
| | PX-200 | | 50 | | | | |
| | comparative compound 1 | | | 50 | | | |
| | comparative compound 2 | | | | 50 | | |
| | distyryl pentaerythritol | | | | | 50 | |
| | diphosphite | | | | | | |
| | allyl phosphate | | | | | | 50 |
| curing accelerator | 25B | 0.5 | 0.5 | 0.5 | 0.5 | 0.5 | 0.5 |
| inorganic filler | SC-2500 SMJ | Z*1.0 | Z*1.0 | Z*1.0 | Z*1.0 | Z*1.0 | Z*1.0 |
| solvent | toluene | PA | PA | PA | PA | PA | PA |
| | MEK | PA | PA | PA | PA | PA | PA |

| Property test | Unit | C1 | C2 | C3 | C4 | C5 | C6 |
|---|---|---|---|---|---|---|---|
| DMA-Tg | ° C. | 230 | 200 | 238 | 231 | 199 | 209 |
| Z-PTE | % | 1.75 | 2.65 | 1.55 | 1.85 | 2.95 | 2.25 |
| T288 | minute | 38 | 32 | >60 | 34 | 23 | 29 |
| flame retardancy | none | V-0 | V-0 | V-0 | V-0 | V-0 | V-0 |
| flame retardant | none | yes | yes | no | yes | no | no |
| migration | | | | | | | |
| flame retardant | none | Y | N | N | Y | N | N |
| detachment | | | | | | | |
| bonding gap | none | yes | none | none | yes | none | none |

Resin compositions from Table 1 to Table 3 were used to make varnishes and various samples (specimens) as described below and tested under conditions specified below so as to obtain the test results.

### 1. Varnish

Components of the resin composition from each Example (abbreviated as E, such as E1 to E10) or Comparative Example (abbreviated as C, such as C1 to C6) were added to a stirrer according to the amounts listed in Tables 1-3 for stirring and well-mixing to form a resin varnish.

For example, in Example E1, 100 parts by weight of a maleimide resin (X9-470) and 20 parts by weight of a phosphorus-containing compound 1 were added to a stirrer containing a proper amount of toluene and a proper amount of methyl ethyl ketone (i.e., a proper amount (abbreviated as “PA”) in Tables 1-3 represents an amount of solvent suitable for obtaining a desired solid content for the resin composition, such as a solid content of the varnish being 70 wt %), and the solution was mixed and stirred to fully dissolve the solid ingredients to form a homogeneous liquid state. Then “Z*1.0” parts by weight of spherical silica (SC-2500 SMJ, i.e., 120 parts by weight) were added and well dispersed, followed by adding 0.5 part by weight of a curing accelerator (25B, pre-dissolved by a proper amount of solvent) and stirring for 1 hour to obtain the varnish of resin composition E1.

In addition, according to the components and amounts listed in Table 1 to Table 3 above, varnishes of Examples E2 to E10 and Comparative Examples C1 to C6 were prepared following the preparation process of the varnish of Example E1.

### 2. Prepreg (Using 2116 E-Glass Fiber Fabric)

Resin compositions from different Examples (E1 to E10) and Comparative Examples (C1 to C6) listed in Table 1 to Table 3 were respectively added to a stirred tank, well mixed and fully dissolved as varnishes and then loaded to an impregnation tank. A fiberglass fabric (e.g., 2116 E-glass fiber fabric) was passed through the impregnation tank to adhere the resin composition on the fiberglass fabric, followed by heating at 120° C. to 150° C. to the semi-cured state (B-Stage) to obtain the prepreg (resin content of about 52%).

### 3. Copper-Clad Laminate 1 (Obtained by Laminating Eight Prepregs)

Two 18 μm reverse treat foils (RTF copper foils) and eight prepregs made from each resin composition (using 2116 E-glass fiber fabrics) were prepared batchwise. Each prepreg has a resin content of about 52%. A copper foil, eight prepregs and a copper foil were superimposed in such order and then subjected to a vacuum condition for lamination at 210° C. for 2 hours to form each copper-clad laminate 1. Insulation layers were formed by curing (C-stage) eight sheets of superimposed prepreg between the two copper foils, and the resin content of the insulation layers was about 52%.

### 4. Copper-Clad Laminate 2 (Obtained by Laminating Six Prepregs)

Two 18 μm reverse treat foils (RTF copper foils) and six prepregs made from each resin composition (using 2116 E-glass fiber fabrics) were prepared batchwise. Each prepreg has a resin content of about 52%. A copper foil, six prepregs and a copper foil were superimposed in such order and then subjected to a vacuum condition for lamination at 210° C. for 2 hours to form each copper-clad laminate 2. Insulation layers were formed by curing (C-stage) six sheets of superimposed prepreg between the two copper foils, and the resin content of the insulation layers was about 52%.

### 5. Copper-Free Laminate 1 (Obtained by Laminating Eight Prepregs)

Each copper-clad laminate 1 was etched to remove the two copper foils to obtain a copper-free laminate 1, which was made from laminating eight prepregs and had a resin content of about 52%.

### 6. Copper-Free Laminate 2 (Obtained by Laminating Six Prepregs)

Each copper-clad laminate 2 was etched to remove the two copper foils to obtain a copper-free laminate 2, which was made from laminating six prepregs and had a resin content of about 52%.

For each sample, test items and test methods are described below.

### 1. Glass Transition Temperature (DMA-Tg)

The copper-free laminate 1 sample was subjected to the glass transition temperature measurement. A dynamic mechanical analyzer (DMA) was used by reference to the method described in IPC-TM-650 2.4.24.4, during which each sample was heated from 50° C. to 400° C. at a heating rate of 2° C./minute and then subjected to the measurement of glass transition temperature (DMA-Tg, in ° C.). A higher glass transition temperature is more preferred, and a difference in glass transition temperature of greater than or equal to 5° C. represents a significant difference (i.e., significant technical difficulty) in glass transition temperature of different samples.

For example, articles made from the resin composition containing the phosphorus-containing compound of Formula (I) disclosed herein have a glass transition temperature as measured by reference to IPC-TM-650 2.4.24.4 of greater than or equal to 245° C., such as between 245° C. and 269° C. or between 258° C. and 269° C.

### 2. Ratio of Thermal Expansion in Z-Axis (Z-PTE)

The copper-free laminate 2 sample was subjected to thermal mechanical analysis (TMA) during the measurement of ratio of thermal expansion in Z-axis. The copper-free laminate 2 was cut into a sample with a length of 10 mm and a width of 10 mm. Each sample was heated from 35° C. to 300° C. at a temperature increase rate of 10° C./minute and then subjected to the measurement of ratio of thermal expansion (%) in Z-axis from 50° C. to 260° C. by reference to the processes described in IPC-TM-650 2.4.24.5. Lower ratio of thermal expansion in Z-axis represents a better property of the sample. Generally, a difference in ratio of thermal expansion in Z-axis of greater than or equal to 0.1% represents a substantial difference (i.e., significant technical difficulty).

For example, articles made from the resin composition containing the phosphorus-containing compound of Formula (I) disclosed herein have a ratio of thermal expansion in Z-axis as measured by reference to IPC-TM-650 2.4.24.5 of less than or equal to 1.45%, such as between 0.95% and 1.45% or between 0.95% and 1.21%.

### 3. T288 Thermal Resistance

The copper-clad laminate 2 sample (6.5 mm*6.5 mm in size) was subjected to the T288 thermal resistance test. At a constant temperature of 288° C., a thermal mechanical analyzer (TMA) was used by reference to IPC-TM-650 2.4.24.1 to test each sample and record the time to delamination (e.g., blistering) of the copper-clad laminate. Longer time to delamination represents better thermal resistance of the copper-clad laminate made from the resin composition. If no delamination was observed after 60 minutes in the test, a designation of “>60” was given, indicating no delamination after more than 60 minutes in the T288 thermal resistance test.

For example, articles made from the resin composition containing the phosphorus-containing compound of Formula (I) disclosed herein were characterized by a time to delamination as measured by using a thermal mechanical analyzer by reference to IPC-TM-650 2.4.24.1 of greater than or equal to 50 minutes, such as a time to delamination of greater than or equal to 60 minutes, between 50 minutes and 100 minutes or between 50 minutes and 80 minutes.

### 4. Flame Retardancy

The copper-free laminate 1 sample was subjected to the flame retardancy test. The flame retardancy test was performed in accordance with the UL 94 rating, and the results were represented by V-0, V-1, or V-2, wherein V-0 indicates a superior flame retardancy to V-1, and V-1 indicates a superior flame retardancy to V-2.

For example, articles made from the resin composition containing the phosphorus-containing compound of Formula (I) disclosed herein have a flame retardancy of V-0 or V-1 as measured by reference to UL 94 rating, such as a flame retardancy of V-0.

### 5. Flame Retardant Migration

The two copper-free laminate 1 samples were subjected to the flame retardant migration test. One sample was not immersed in solder, and the other sample was immersed in solder by reference to the process described in IPC-TM-650 2.4.23. The copper-free laminate 1 was immersed in a 288° C. solder bath for 20 seconds and then removed therefrom. The two copper-free laminates 1, soldered and unsoldered, were compared by visual inspection to observe if the surface of the soldered copper-free laminate 1 differs from the surface of the unsoldered copper-free laminate 1, such as becoming brighter or having foreign substances. If the surface became brighter or had foreign substances, the Fourier-transform infrared spectroscopy (FTIR) test would be conducted. The FTIR spectrum of the substances found on the surface of the copper-free laminate 1 was then compared with the FTIR spectrum of the flame retardant used in the copper-free laminate 1. If they are similar, it is confirmed that the flame retardant has migrated, recorded as “yes”. If no abnormalities are observed on the surface of the copper-free laminate 1, it is considered as absence of flame retardant migration, recorded as “no”.

### 6. Flame Retardant Detachment

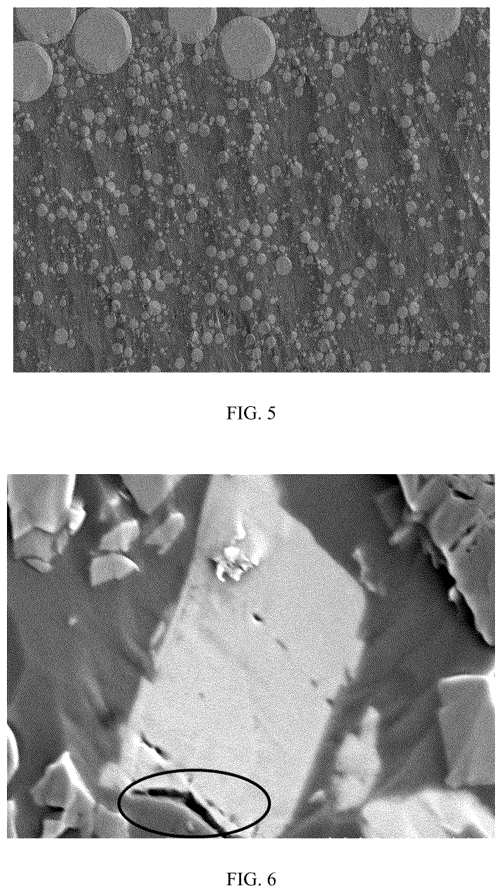

The copper-free laminate 1 sample was subjected to the flame retardant detachment test. A 1.5 cm copper-free laminate 1 sample was subjected to various slicing processes known in the art, such as resin filling, grinding, cleaning, polishing and gold plating, to make a qualified section, which was then placed in an ultrasonic cleaning machine (with ultrasonic power frequency set at 40 KHz) to vibrate for 10 minutes and then removed therefrom. After drying, the section was observed by using a scanning electron microscope (SEM). The appearance of the resin layer can be clearly observed with a magnification ranging from 500× to 2000×. 2000× magnification was used in the present disclosure to observe rectangular samples in order. When a void is observed in the sample section, as shown in FIG. 4, it is confirmed as flame retardant detachment, recorded as “Y”. When no voids are observed in the sample section, as shown in FIG. 5, it is confirmed as absence of flame retardant detachment, recorded as “N”. As used herein, the term “flame retardant detachment” refers to the separation or detachment of flame retardant from the cross-sectional surface of an article made from the resin composition of the present disclosure, such as but not limited to a copper-clad laminate or a printed circuit board.

When the flame retardant in the laminate has detachment under external force, such as under ultrasonic vibration, it is considered that the flame retardant will also have detachment during the subsequent processes of the printed circuit board (PCB). If flame retardant detachment occurs during external force such as drilling (example such as laser drilling, which involves both vibration and heating condition), it will cause uneven surfaces in the hole walls formed after drilling, leading to quality issues during electroplating circuits, potentially causing PCB reliability problems. Therefore, the absence of flame retardant detachment is one of the important quality items of the laminate.

### 7. Bonding Gap

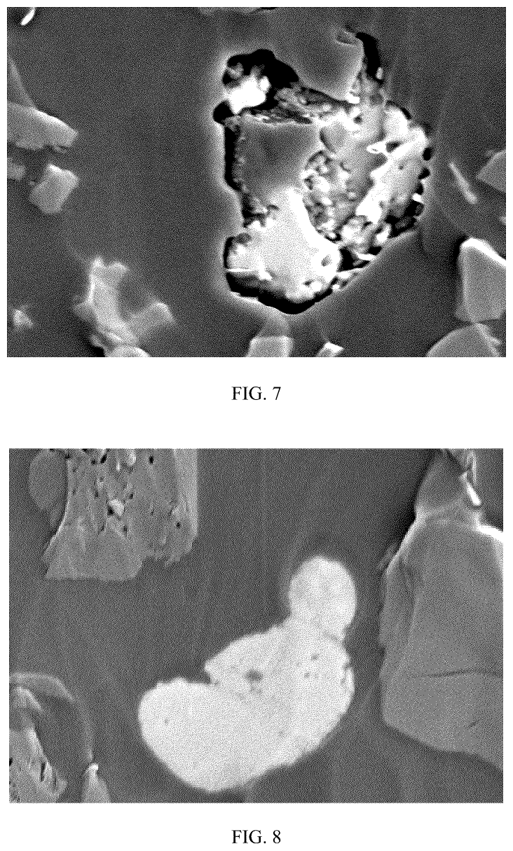

The copper-free laminate 1 sample was subjected to the bonding gap test. The test sample was cut into a rectangular sample with a length of 2.0 cm×1.5 cm from both warp and filling directions respectively, which was cleaned ultrasonically for 1 minute separately. After cleaning ultrasonically twice, the rectangular samples were subjected to various slicing processes known in the art, such as resin filling, grinding, cleaning, polishing and gold plating, to make a qualified section, which was then observed by using a scanning electron microscope (SEM). At a 20000× magnification, the presence or absence of bonding gap at the interface between the flame retardant and resin in the sample sections can be observed in order. When bonding gap is observed at the interface between the flame retardant and resin in one of the sample sections, as shown in FIG. 6 and FIG. 7, it is confirmed as presence of bonding gap, such as the strip-shaped bonding gap shown in the black circle in FIG. 6 or the annular bonding gap around the flame retardant in FIG. 7. The shape and width of the bonding gap are not particularly limited. As long as there is a bonding gap, it is recorded as “yes”. When no bonding gap is observed at the interface between the flame retardant and resin in both sample sections, as shown in FIG. 8, it is confirmed as absence of bonding gap, recorded as “none”.

When bonding gap is present at the interface between the flame retardant and resin in the laminate, it may form channels for ion migration, negatively affecting subsequent PCB reliability.

The following observations can be made from Table 1 to Table 3.

From a side-by-side comparison of Examples E2 and E5 with Comparative Example C1, it can be confirmed that the phosphorus-containing compound of Formula (I) disclosed herein, compared to FCX-210, can achieve one or more of the following technical effects: increasing glass transition temperature, reducing ratio of thermal expansion in Z-axis, improving T288 thermal resistance, improving flame retardant migration, improving flame retardant detachment and improving bonding gap.

From a side-by-side comparison of Examples E2 and E5 with Comparative Example C3, it can be confirmed that the phosphorus-containing compound of Formula (I) disclosed herein, compared to comparative compound 1, can achieve one or more of the following technical effects: increasing glass transition temperature and reducing ratio of thermal expansion in Z-axis.

From a side-by-side comparison of Examples E2 and E5 with Comparative Example C4, it can be confirmed that the phosphorus-containing compound of Formula (I) disclosed herein, compared to comparative compound 2, can achieve one or more of the following technical effects: increasing glass transition temperature, reducing ratio of thermal expansion in Z-axis, improving T288 thermal resistance, improving flame retardant migration, improving flame retardant detachment and improving bonding gap.

From a side-by-side comparison of Examples E2 and E5 with Comparative Example C5, it can be confirmed that the phosphorus-containing compound of Formula (I) disclosed herein, compared to distyryl pentaerythritol diphosphite, can achieve one or more of the following technical effects: increasing glass transition temperature, reducing ratio of thermal expansion in Z-axis and improving T288 thermal resistance.

From a side-by-side comparison of Examples E2 and E5 with Comparative Example C2 or C6, it can be confirmed that the phosphorus-containing compound of Formula (I) disclosed herein, compared to other phosphate ester flame retardants that do not contain pentaerythritol spiroheterocycles (such as PX-200 and allyl phosphate), can achieve one or more of the following technical effects: increasing glass transition temperature, reducing ratio of thermal expansion in Z-axis, improving T288 thermal resistance and improving flame retardant migration.

From a comparison of Examples E1 and E3 with Examples E9 and E10, it can be confirmed that if the amount of the phosphorus-containing compound of Formula (I) is within the range of 20 parts by weight to 70 parts by weight, compared to the amount of 10 parts by weight or 80 parts by weight, one or more of the following technical effects can be achieved: increasing glass transition temperature, reducing ratio of thermal expansion in Z-axis, improving T288 thermal resistance and improving flame retardancy.

From a comparison of Examples E1 to E10 with Comparative Examples C1 to C6, it can be confirmed that articles made from the phosphorus-containing compound of Formula (I) disclosed herein can achieve one, more or all of the following technical effects: a glass transition temperature of greater than or equal to 245° C., a ratio of thermal expansion in Z-axis of less than or equal to 1.45%, a time to delamination of greater than or equal to 50 minutes, a UL 94 flame retardancy of V-0 or V-1, no flame retardant migration, no flame retardant detachment and no bonding gap. In contrast, Comparative Examples C1-C6 not using the technical solution of the present disclosure fail to achieve the aforesaid technical effects at the same time.

The above detailed description is merely illustrative in nature and is not intended to limit the embodiments of the subject matter or the application and uses of such embodiments. As used herein, the term “exemplary” means “serving as an example, instance, or illustration.” Any implementation described herein as exemplary is not necessarily to be construed as more preferred or advantageous over other implementations.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description will provide those skilled in the art with a convenient guide for implementing the described one or more embodiments. Also, various changes can be made in the function and arrangement of elements without departing from the scope defined by the claims, which include known equivalents and all foreseeable equivalents at the time of filing this patent application.

What is claimed is:

1. A phosphorus-containing compound having a structure represented by Formula (I): 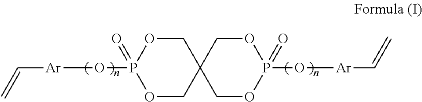
wherein n is 0 or 1, and Ar group represents a divalent aromatic hydrocarbon group.

2. The phosphorus-containing compound of claim 1, wherein the divalent aromatic hydrocarbon group comprises a phenylene group, a naphthylene group, or a biphenylene group.

3. The phosphorus-containing compound of claim 1, wherein the divalent aromatic hydrocarbon group is unsubstituted.

4. The phosphorus-containing compound of claim 1, which has a structure represented by Formula (II):

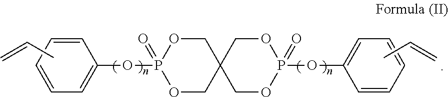

5. The phosphorus-containing compound of claim 1, which has a structure represented by Formula (III):

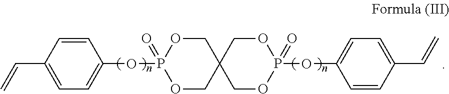

6. The phosphorus-containing compound of claim 1, having a phosphorus content of between 9% and 15%.

7. A method of preparing the phosphorus-containing compound having the structure represented by Formula (I) of claim 1, comprising: reacting a compound of Formula (A) with a compound of Formula (B) to obtain the phosphorus-containing compound having the structure represented by Formula (I): 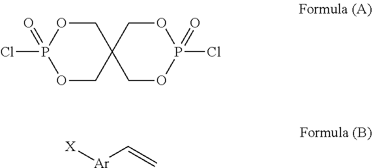
wherein X represents a hydroxyl group or a magnesium halide group, and Ar group represents a divalent aromatic hydrocarbon group.

8. The method of claim 7, further comprising reacting pentaerythritol with phosphorus oxychloride to obtain the compound of Formula (A).

9. The method of claim 7, wherein the compound of Formula (A) and the compound of Formula (B) are reacted in the presence of a deacid reagent.

10. The method of claim 7, wherein the compound of Formula (A) and the compound of Formula (B) are reacted in the absence of a deacid reagent.

11. The method of claim 7, wherein the compound of Formula (B) is hydroxystyrene, styryl magnesium bromide or styryl magnesium chloride.

12. A resin composition comprising 100 parts by weight of a maleimide resin and 10 parts by weight to 80 parts by weight of the phosphorus-containing compound of claim 1.

13. The resin composition of claim 12, wherein the maleimide resin comprises 4,4′-diphenylmethane bismaleimide, oligomer of phenylmethane maleimide, biphenyl aralkyl bismaleimide, indane-containing bismaleimide, m-phenylene bismaleimide, bisphenol A diphenyl ether bismaleimide, 3,3′-dimethyl-5,5′-diethyl-4,4′-diphenyl methane bismaleimide, 4-methyl-1,3-phenylene bismaleimide, 1,6-bismaleimide-(2,2,4-trimethyl)hexane, N-2,3-xylylmaleimide, N-2,6-xylylmaleimide, N-phenylmaleimide, maleimide resin containing a C₅ to C₅₀ aliphatic long-chain structure, or a combination thereof.

14. The resin composition of claim 12, comprising 100 parts by weight of the maleimide resin and 20 parts by weight to 70 parts by weight of the phosphorus-containing compound of claim 1.

15. The resin composition of claim 12, further comprising an amine curing agent, an inorganic filler, a curing accelerator, a polymerization inhibitor, a coloring agent, a solvent, a toughening agent, a silane coupling agent or a combination thereof.

16. An article made from the resin composition of claim 12, wherein the article comprises a prepreg, a resin film, a laminate, a printed circuit board or a cured insulator.

17. The article of claim 16, which has one, more or all of the following properties:
a glass transition temperature as measured by using dynamic mechanical analysis by reference to IPC-TM-650 2.4.24.4 of greater than or equal to 245° C.;
a ratio of thermal expansion in Z-axis as measured by using thermal mechanical analysis by reference to IPC-TM-650 2.4.24.5 of less than or equal to 1.45%;
a time to delamination as measured by using thermal mechanical analysis by reference to IPC-TM-650 2.4.24.1 of greater than or equal to 50 minutes;
a flame retardancy of V-0 or V-1 as measured by reference to UL 94 rating;
no flame retardant migration as determined by visual inspection;
no flame retardant detachment as determined by scanning electron microscope inspection; and
no bonding gap as determined by scanning electron microscope inspection.
